(19) United States
(12) Patent Application Publication
(10) Pub. No.: US 2026/0014037 A1
(43) Pub. Date: Jan. 15, 2026

(54) MOBILITY SYSTEM AND METHODS OF OPERATION

(71) Applicant: Honda Motor Co., Ltd., Tokyo (JP)

(72) Inventors: Brian Karl LICKFELT, Powell, OH (US); Kentaro Yoshimura, Dublin, OH (US)

(21) Appl. No.: 18/771,160

(22) Filed: Jul. 12, 2024

(51) Int. Cl. A61G 3/06; A61G 3/02; G01C 21/20; G01S 13/02

(52) U.S. Cl. CPC A61G 3/062; A61G 3/0209; G01C 21/20; G01S 13/0209

(57) ABSTRACT

Systems and methods that make it simpler for physically challenged users to store and retrieve a mobility device on or in a motor vehicle include autonomously storing the mobility device after the user enters the motor vehicle, and autonomously positioning the mobility device outside of a vehicle door when the user is ready to exit the motor vehicle. The systems use an ultra-wideband (UWB) system to determine location information for the mobility device.

### BACKGROUND

The present disclosure relates to motor vehicles and in particular to systems and methods for using mobility devices with motor vehicles.

Physically challenged individuals often use mobility devices, such as wheelchairs, to move around. To use a mobility device while an individual is out and about, the mobility device needs to be transported in the cargo area or loaded on a hitch-mounted platform of a user’s vehicle. For physically challenged individuals it may be difficult to move between a cabin of the vehicle and the rear of the vehicle for mounting and unmounting of the mobility device.

There is a need in the art for a system and method that addresses the shortcomings discussed above.

### SUMMARY

Embodiments provided herein disclose a mobility system and methods of operating the mobility system. The mobility system includes a mobility device that may be autonomously maneuvered around a motor vehicle. The mobility device may be stored in or on the motor vehicle and used by physically challenged individuals.

In some aspects, the techniques described herein relate to a system including a motor vehicle. The motor vehicle includes a plurality of ultra-wideband anchors and a positioning system for determining location information from signals received at the plurality of ultra-wideband anchors. The system includes a mobility device that further includes an autonomous driving system and an ultra-wideband tag. The motor vehicle is configured to receive signals from the ultra-wideband tag at the plurality of ultra-wideband anchors, determine position information for the mobility device using the positioning system and the signals from the ultra-wideband tag, and transmit the position information to the mobility device. The mobility device is configured to receive the position information and autonomously drive the mobility device using the autonomous driving system and the position information.

In some aspects, the techniques described herein relate to a method of operating a motor vehicle. The method includes operations of receiving, at a plurality of ultra-wideband anchors attached to the motor vehicle, signals from an ultra-wideband tag attached to a mobility device, calculating position information for the mobility device relative to the motor vehicle using the signals from the ultra-wideband tag, and transmitting the position information to the mobility device.

In some aspects, the techniques described herein relate to a method of operating a mobility device. The method includes operations of emitting a signal using an ultra-wideband tag attached to the mobility device, where the signal is configured to be received and processed by a motor vehicle with a plurality of ultra-wideband anchors. The method also includes operations of receiving location information for the mobility device from the motor vehicle with the plurality of ultra-wideband anchors and autonomously driving, using an autonomous driving system of the mobility device, the mobility device according to the location information.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments may be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIGS. 1 and 2 are schematic views of a mobility system, according to an embodiment.

FIG. 3 depicts hardware and software components associated with a mobility system, according to an embodiment.

FIGS. 4-11 are schematic views depicting the operation of a mobility system according to an embodiment.

FIG. 12 is a schematic view of a process for a mobility system, according to an embodiment.

### DETAILED DESCRIPTION

The embodiments provide systems and methods that make it simpler for physically challenged users to store and retrieve a mobility device that may be stored in or on a motor vehicle. Specifically, the systems and methods facilitate autonomously storing the mobility device after the user enters the motor vehicle, and autonomously positioning the mobility device outside of a vehicle door when the user is ready to exit the motor vehicle. The embodiments make use of an Ultra-wideband (UWB) system of a motor vehicle, which communicates with an autonomous driving system on the mobility device. Using the exemplary system, the user may get off of the mobility device at the driver door, and, using autonomous controls, the mobility device may guide itself to an associated transportation lift located at the rear or other part of the motor vehicle. Likewise, immediately after a vehicle has been parked, the exemplary system automatically summons the mobility device to meet the user at the appropriate door of the vehicle.

In some embodiments, UWB anchors associated with a parking area (for example, a garage) may be used to guide a mobility device from the motor vehicle to a wireless charging pad or other charging station. In some cases, a system may be summoned from a charging station to an appropriate door of a house to transport the user from the house to the vehicle.

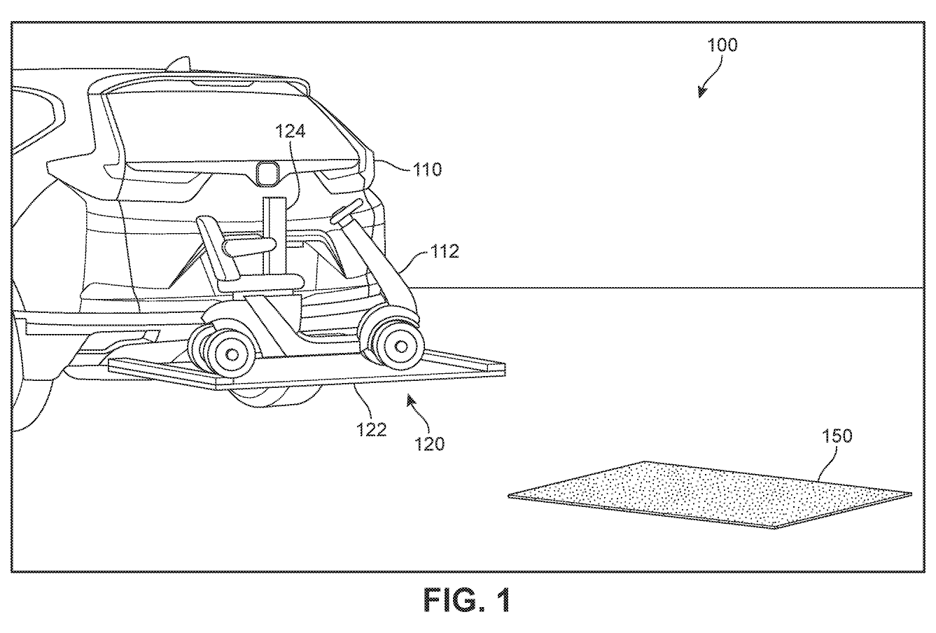

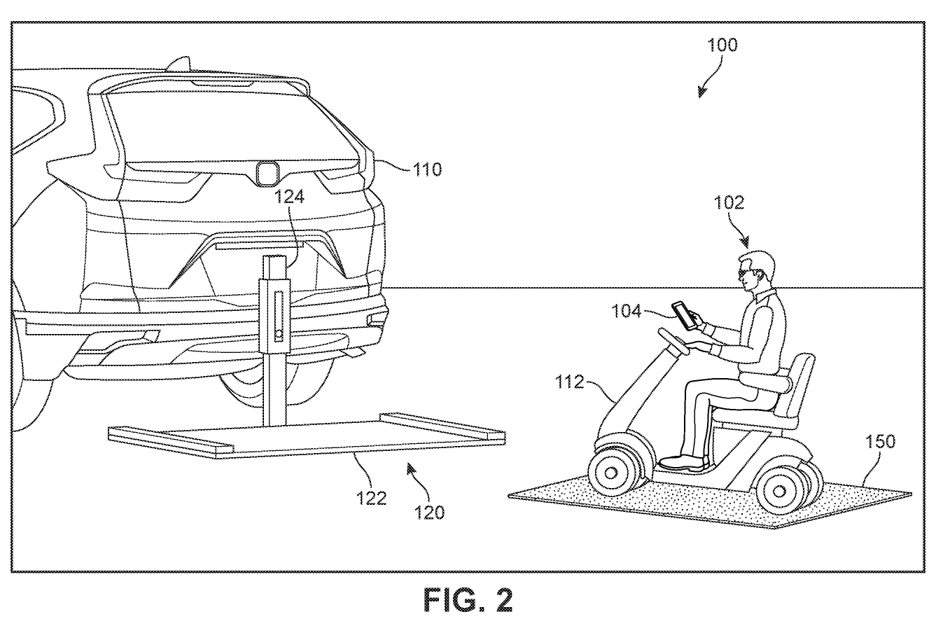

FIGS. 1 and 2 are schematic views of a mobility system 100 that facilitates the mobility of a user 102 who may be physically challenged in some capacity. Mobility system 100 is further comprised of a motor vehicle 110 that facilitates the transport of user 102 over large distances (and over roads), and a personal mobility device 112 (or, simply “mobility device 112”) that facilitates the transport of user 102 over shorter ranges, including to and from motor vehicle 110. In some cases, user 102 may be a passenger of motor vehicle 110. In some cases, user 102 may be a driver of motor vehicle 110.

Motor vehicle 110 may be a non-autonomous vehicle, a semi-autonomous vehicle, or fully autonomous vehicle, for example, as defined by National Highway Traffic Safety Administration (NHTSA). Examples of the vehicles may include, but are not limited to, a three-wheeler vehicle, a four-wheeler vehicle, a hybrid vehicle, or a vehicle with autonomous drive capability that uses one or more distinct renewable or non-renewable power sources. Motor vehicle 110 may use renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. Motor vehicle 110 may have load carrying capabilities that uses one or more distinct trailers. It should be noted here that motor vehicle 110 is shown in FIGS. 1-2 as a four-wheeler vehicle, which is merely an example.

Mobility device 112 may comprise any suitable device that facilitates the mobility/transportation of a user. In the embodiments, mobility device 112 may be a powered device. Exemplary devices include wheelchairs, scooters, and other powered devices. A mobility device may be electrically powered, or powered by any other suitable propulsion technology. In some embodiments, mobility device 112 may comprise at least one electric motor and at least one electric battery for powering the at least one electric motor. Moreover, in some embodiments, the electric battery may be rechargeable. In some cases, the electric battery may be rechargeable via wireless charging. As seen in FIGS. 1-2, mobility device 112 is shown as an electric wheelchair, however this is only an example of a mobility device that may be used.

Mobility system 100 may further include provisions for storing and/or mounting mobility device 112 inside of, or on, motor vehicle 110. As seen in FIGS. 1-2, mobility system 100 includes lift system 120. Lift system 120 comprises a platform 122 that may be raised and lowered relative to a lifting assembly 124 that is fixed with respect to motor vehicle 110.

Lift system 120 may be mounted to motor vehicle 110. Specifically, lift system 120 is mounted to a rear side (or rearward end) of motor vehicle 110. In some cases, lift system 120 may be attached to a hitch mount. In other cases, lift system 120 may be mounted using any other suitable attachments. Using lift system 120, mobility device 112 may be raised for stowing while motor vehicle 110 transports a user from one location to another. Likewise, mobility device 112 may be lowered using lift system 120. It may be appreciated that lift system 120 may also include mechanisms for retaining mobility device 112 in place on platform 122 so that mobility device 112 doesn’t fall off of lift system 120 as motor vehicle 110 is driven. In some embodiments, these retaining mechanisms (such as latches, clamps, gates, or other mechanisms) may be controlled automatically so that a user need not be present at lift system 120 to retain mobility device 112 on platform 122.

Although FIGS. 1-2 show a lift, other embodiments may utilize other provisions for storing and/or mounting a mobility device. Examples include interior lifts, ramps, and other systems that facilitate storing a mobility device within a compartment of a vehicle (such as the trunk or rear cargo area). In some embodiments, a mobility device may be stowed in a vehicle cabin or other storage area accessible by a side door of the vehicle.

As discussed in further detail below, the embodiments provide systems and methods that allow mobility device 112 to be automatically summoned from lift system 120 to an appropriate vehicle door of motor vehicle 110 where a user may be waiting. The embodiments provide systems and methods that allow mobility device 112 to automatically return to lift system 120 from any region adjacent motor vehicle 110 when a user transitions from mobility device 112 back to motor vehicle 110.

In some embodiments, a user may be equipped with a personal device that may communicate with other components of mobility system 100. For example, user 102 may have a user device 104. In this example, user device 104 comprises a mobile phone (or smartphone). In other cases, a user device could comprise a smartwatch or other wearable, a tablet computer, or any other suitably mobile computing device. In some cases, components of user device 104 may be used to determine a precise location for user 102 to facilitate the operation of mobility system 100. For example, some functions of mobility system 100 may be use a location of user 102 relative to motor vehicle 110 and/or mobility device 112.

As seen in FIGS. 1-2, some embodiments of mobility system 100 may also include a home docking station 150. Home docking station 150 may have a fixed location at a user’s home, for example, in a user’s garage. The exemplary embodiment provide systems and methods for automatically moving mobility device 112 to home docking station 150 when mobility device 112 is near home docking station 150 and not in use. Home docking station 150 may include a wireless charging pad or other component to facilitate recharging of the batteries of mobility device 112.

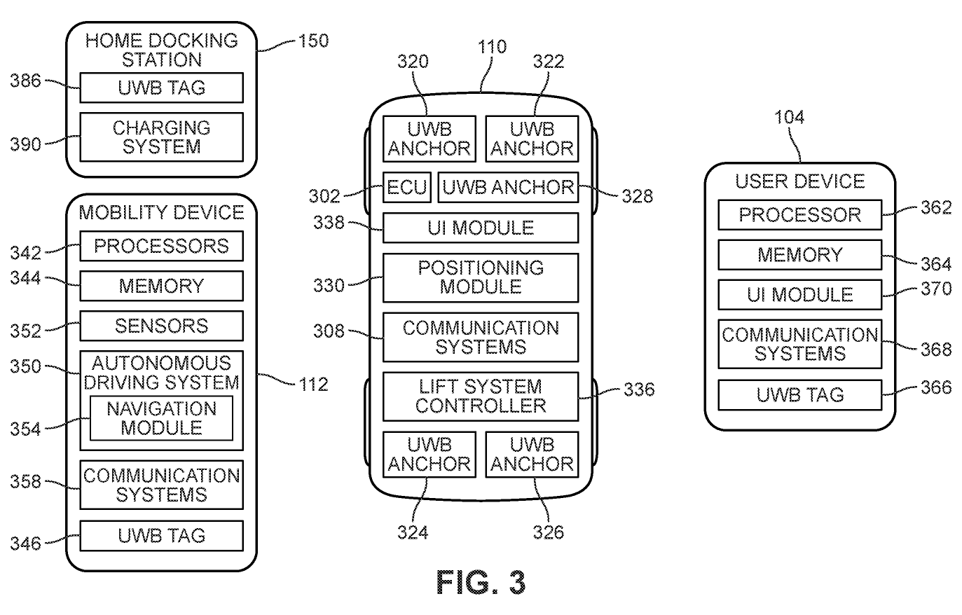

FIG. 3 depicts some hardware and software components associated with mobility system 100. As seen in FIG. 3, each of motor vehicle 110, mobility device 112, user device 104 and home docking station 150 may comprise one or more hardware and/or software components.

Each device, vehicle or other component may include suitable processors and/or memory. For example, motor vehicle 110 may include at least one electronic control unit (“ECU”) 302. ECU 302 may comprise one or more discrete computing systems that may each include one or more processors, as well as non-transitory computer-readable media (memory) for storing instructions that may be executed by the one or more processors. In some cases, various different systems of motor vehicle 110 may be operated by different ECUs.

Each of mobility device 112 and user device 104 may include both processors and memory. Specifically, mobility device 112 includes processors 342 and memory 344, while user device 104 includes processors 362 and memory 364. Although not shown in FIG. 3, home docking station 150 may also include suitable processors and memory. ECUs, processors, and memory may all be used to perform suitable computational processes to facilitate the operation of mobility system 100.

In some embodiments, one or more devices, vehicles or other components of mobility system 100 may comprise hardware and/or software associated with an ultra-wideband system. In some embodiments, an ultra-wideband system includes components configured to transmit and/or receive signals over ultra-wideband frequencies. In some cases, an ultra-wideband system may be used for transmitting data between two or more devices. In some cases, an ultra-wideband system may be used for locating one or more objects or devices. An ultra-wideband system may comprise two or more ultra-wideband (UWB) devices that communicate using ultra-wideband frequencies. In some embodiments, each UWB device may be capable of transmitting and receiving information over ultra-wideband frequencies. That is, each UWB device may comprise at least one of a transmitter and a receiver, as well as other suitable components.

Embodiments may utilize different UWB topologies or techniques, including two-way ranging that requires only two UWB devices and time difference of arrival which requires multiple UWB devices arranged in a fixed/known configuration to receive transmissions from a UWB device whose location is to be determined. In embodiments where some UWB devices have fixed locations, the fixed UWB devices may be referred to as “UWB anchors”. In this case, the mobile UWB devices, with locations to be determined, may be referred to as “UWB tags”.

Some embodiments may use the time difference of arrival technique, in which a UWB tag sends out signals that are captured by multiple UWB anchors. Using time-of-flight information, information received at the multiple UWB anchors may be used to determine (calculate) a position for the UWB tag. In particular, when the UWB anchors have a fixed location relative to one another, the system may determine a relative position of the UWB tag, which is relative to a known position or reference system associated with the UWB anchors. In some cases, each anchor passes relevant measurements / signal information received from the UWB tag to a central gateway or engine that calculates a relative location for the UWB tag.

As shown in FIG. 3, motor vehicle 110 includes a plurality of UWB anchors. These may include four anchors disposed at the four corners of motor vehicle 110. Specifically, a first anchor 320, a second anchor 322, a third anchor 324, and a fourth anchor 326. In some embodiments, each of first anchor 320, second anchor 322, third anchor 324, and fourth anchor 326 may be disposed at a corresponding corner of motor vehicle 110, including a front-left corner, a front-right corner, a rear-left corner, and a rear-right corner. Motor vehicle 110 may also include at least one anchor 328 disposed within an interior cabin of motor vehicle 110. In some cases, motor vehicle 110 may include two or more anchors disposed in an interior cabin of motor vehicle 110.

The UWB anchors installed within motor vehicle 110 may operate to detect signals transmitted by UWB tags. The signals may be processed by a positioning module 330, which uses time-of-flight information and suitable algorithms to determine a relative location of the associated UWB tag. That is, positioning module 330 operates as a centralized gateway or engine for processing signal information from multiple sources (anchors) and determining a location for a tag. In some cases, positioning module 330 may be integrated into one or more of the UWB anchors. In other cases, positioning module 330 may be a centralized module that is stored and run separately from any of the UWB anchors onboard another system of motor vehicle 110. In some embodiments, positioning module 330 may be stored and run on ECU 302. In still other embodiments, a positioning module may run on a remote device or server that communicates with one or more UWB anchors of motor vehicle 110 using a suitable wireless network.

As seen in FIG. 3, each of mobility device 112, user device 104, and home docking station 150 may include a UWB tag. Specifically, mobility device 112 includes UWB tag 346, user device 104 includes UWB tag 366 and home docking station 150 includes UWB tag 386. Each of these tags may independently transmit/emit signals that are received at one or more of the UWB anchors disposed in motor vehicle 110. Based on the received signals, positioning module 330 may determine a relative position/location for each component, which is a location relative to motor vehicle 110.

The embodiments may include provisions for communicating between motor vehicle 110 and one or more of mobility device 112 and user device 104. In some embodiments, information may be exchanged via communication between UBW devices. For example, in some cases, information may be exchanged between one or more UWB anchors disposed in motor vehicle 110 and UWB tag 346 of mobility device 112 and/or UWB tag 366 of mobile device 104.

In other embodiments, communication may be enabled using any other suitable communication components that may communicate over any suitable networks. For example, motor vehicle 110 may include communication systems 308, mobility device 112 may include communication systems 358 and user device 104 may include communication systems 368.

Each of these communications systems may comprise one or more systems for facilitating communication. Such systems may include, but are not limited to, one or more suitable devices, chips, cards, or other systems for communicating over wired and/or wireless networks. Suitable networking components may include a Wi-Fi card, a cellular network card, a Personal Area Network (PAN) card, and a Near Field Communication (NFC) chip. Using these communication systems, components, devices, and vehicles may communicate over any suitable networks, including cellular networks, wireless local area networks, personal area networks, or other suitable networks. In some embodiments, communication systems on a motor vehicle and/or a mobility device may include components that facilitate communication using Bluetooth Low Energy (BLE) technology.

Mobility device 112 may include provisions for autonomous driving, including an autonomous driving system 350. Autonomous driving system 350 may include control systems that facilitate autonomous driving. Exemplary control systems used for autonomous driving include drive-by-wire systems, specifically throttle by wire, brake by wire, shift by wire, steer by wire, and other electrical control systems to facilitate autonomous driving. In some embodiments, control systems may include suitable autonomous systems for controlling electric vehicles, including electric wheelchairs, which are driven using electric motors powered by batteries.

In some embodiments, mobility device 112 includes one or more sensors 352 that receive information that may be used by autonomous driving system 350. Exemplary sensors may include cameras, LIDAR sensors, proximity sensors, and other suitable sensors. In some cases, mobility device 112 may also include a GPS receiver for determining a GPS location of mobility device 112.

In some cases, autonomous driving system 350 may also include an autonomous driving agent. An autonomous driving agent may comprise processors, circuitry, memory, and software for implementing autonomous driving. In particular, an autonomous driving agent may take in information from one or more sensors, make autonomous decisions, and implement automated driving controls via drive-by-wire or other autonomous driving controls.

Autonomous driving system 350 may include a navigation module 354. Navigation module 354 may be used to plan and implement paths for moving mobility device 112 to different areas around motor vehicle 110. In particular, navigation module 354 may plan paths according to the relative location between the mobility device and the motor vehicle at any time, as well as information such as a destination (for example, the rear of the motor vehicle). In some embodiments, navigation module 354 may store a map of a motor vehicle to facilitate path planning for the mobility device. For example, a system may plan a path for a mobility device using information about the mobility device’s relative location, as well as location information for different areas of the motor vehicle, including exterior components of the vehicle (such as doors, front and rear bumpers, various side panels, and other relevant exterior components).

Although the embodiments describe a system where a path for a mobility device may be planned at a system running on the mobility device, in other embodiments, path planning may be done at a system running on motor vehicle 110. In some cases, motor vehicle 110 transmits not only a current location of a mobility device at any given time, but also path information including a portion or all of a path between the mobility device and a destination, which is implemented by autonomous driving system 350.

It may be appreciated that in some cases, autonomous driving system 350 may be engaged only while a user is in/on mobility device 112. In some cases, once a user has sat on mobility device 112, for example, autonomous driving system 350 may automatically disengage to allow the user to control mobility device 112. In some embodiments, autonomous driving system 350 automatically disengages whenever a user’s location and the mobility device’s location, determined using UWB systems, match within a predetermined tolerance.

Some embodiments may include provisions that allow a user to interface with one or more components of mobility system 100, including triggering particular actions such as summoning mobility device 112 and/or instructing mobility device 112 to stow itself at the back of the vehicle. In some cases, one or both of motor vehicle 110 and user device 104 may include a user interface module (for example, UI module 338 of motor vehicle 110 and UI module 370 of user device 104). UI module 338 may comprise part of a software application running on a suitable computing system of motor vehicle 110. In some cases, UI module 370 generates a UI that may be presented to the user on a display integrated into motor vehicle 110. Likewise, UI module 370 may be a mobile application running on user device 104. Either UI module may present a user with options such as summoning a mobility device, stowing a mobility device, as well as options to select a door or other vehicle location where the mobility device should be summoned to (for example, the driver-side door, the passenger-side door, or any other suitable area of the motor vehicle).

As already discussed, motor vehicle 110 may include lift system 120, as shown in FIGS. 1-2. In some cases, lift system 120 may be controlled by one or more onboard vehicle systems, including a lift system controller 336. In some cases, lift system controller 336 may control lift system 120, including the lifting and lowering of platform 122 (see FIGS. 1-2) in response to information received from other systems. As one example, once positioning module 330 determines that mobility device 112 is disposed at a rear of motor vehicle 110, lift system controller 336 may automatically lower platform 122 so that mobility device 112 may autonomously drive onto platform 122. Once positioning module 330 determines that mobility device 112 is disposed on platform 122 lift system 120 (for example, using UWB systems), lift system controller 336 may automatically raise platform 122 and/or engaging any associated provisions for locking/securing mobility device 112 onto platform 122. In some cases, to facilitate improved positioning accuracy, one or more UWB tags may be attached to components of lift system 120, such as to platform 122, enabling the system to better determine exactly when mobility device 112 is positioned correctly on platform 122.

As seen in FIG. 3, in some embodiments, home docking station 150 further includes a charging system 390. In some embodiments, charging system 390 could comprise a wireless charging pad that automatically charges mobility device 112 whenever mobility device 112 is disposed adjacent (or over) the charging pad.

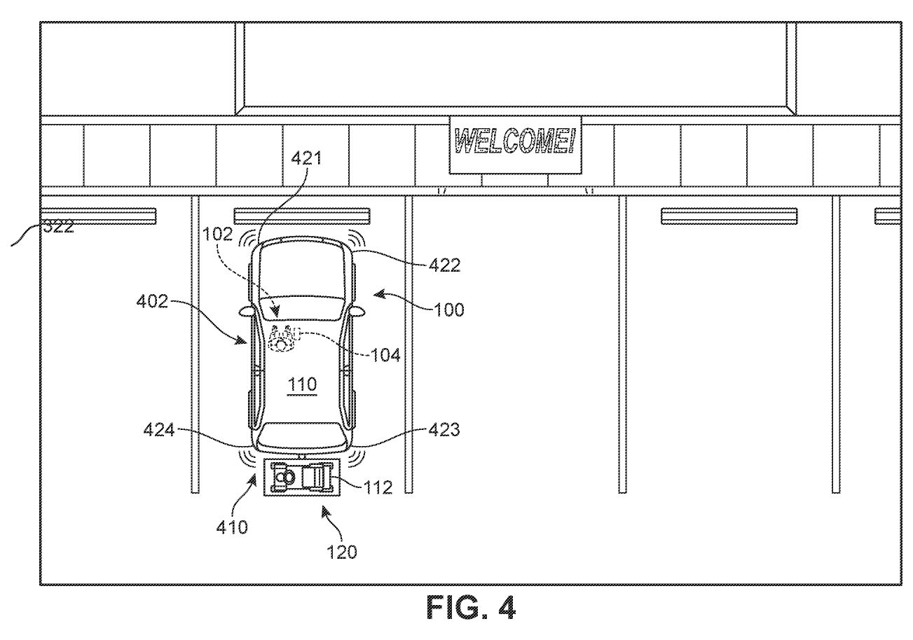

FIGS. 4-11 are schematic views depicting the operation of mobility system 100 according to an embodiment. Specifically, FIGS. 4-11 show schematic top down views of mobility device 112 autonomously driving itself to different areas around motor vehicle 110 according to position information detected using UWB signaling.

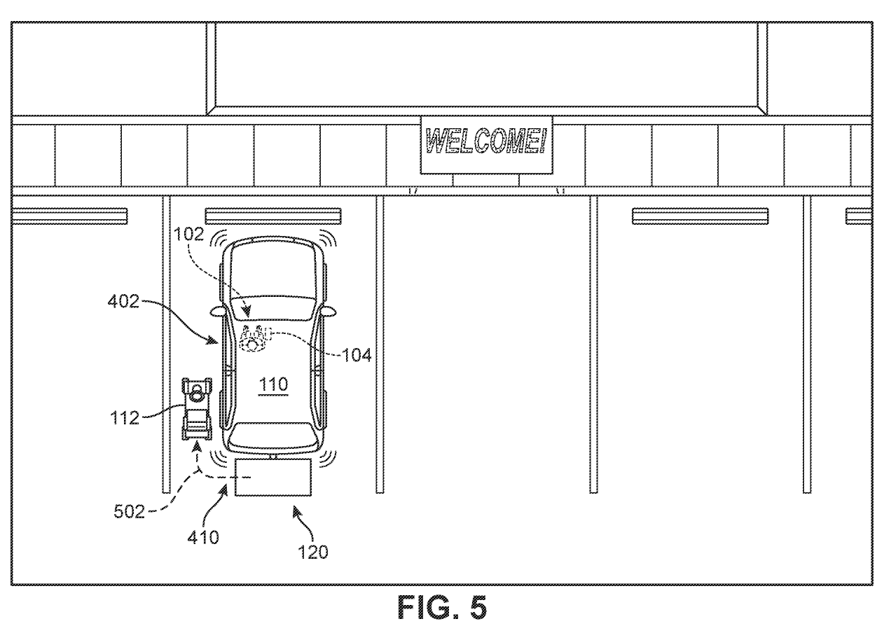

Referring first to FIGS. 4-7, mobility device 112 may be autonomously summoned to a driver-side door 402 of motor vehicle 110. In some cases, this action may be triggered automatically, for example, upon detecting that motor vehicle 110 has been parked. In other cases, this action may be triggered by a user interacting with an associated UI running in motor vehicle 110 and/or on a user device. Upon being summoned, mobility device 112 may be automatically lowered using lift system 120 and may then autonomously drive from a rear side 410 of motor vehicle 110 towards user 102 who is disposed in a driver’s seat of motor vehicle 110, as in FIG. 5. The path 502 taken by mobility device 112 is determined according to the relative location of mobility device 112 at any given time. This relative location is determined as a UWB tag on mobility device 112 broadcasts signals that are received by UWB anchors on motor vehicle 110 and processed to determine location information for mobility device 112. Specifically, UWB signals from a UWB tag on mobility device 112 may be received at UWB anchors located at the four corners of motor vehicle 110, including at first corner 421, second corner 422, third corner 423, and fourth corner 424. For purposes of illustration, FIGS. 4-11 depict UWB signals at each of the four corners of motor vehicle 110 corresponding to one of the onboard UWB anchors. The location information determined at motor vehicle 110 is then transmitted back to the autonomous driving system of mobility device 112.

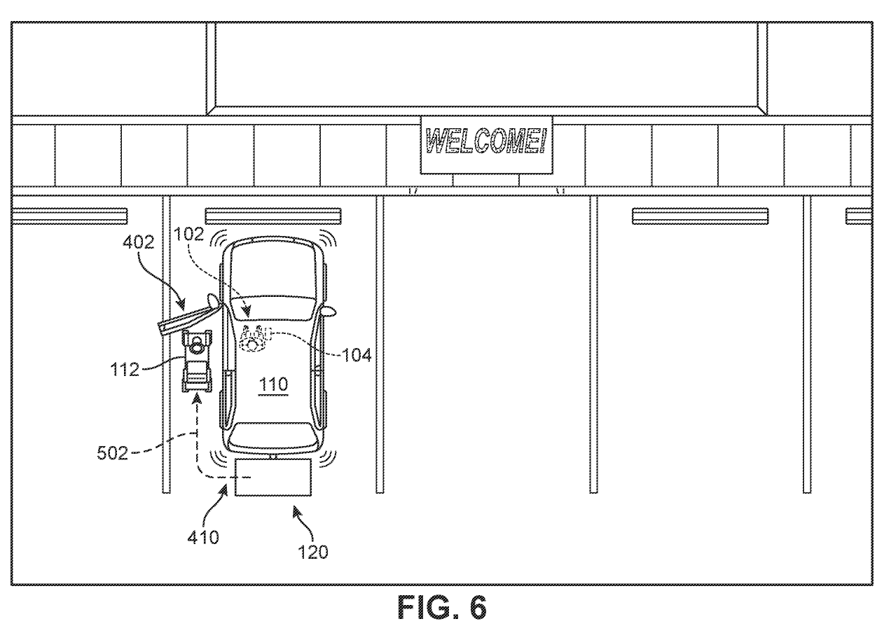

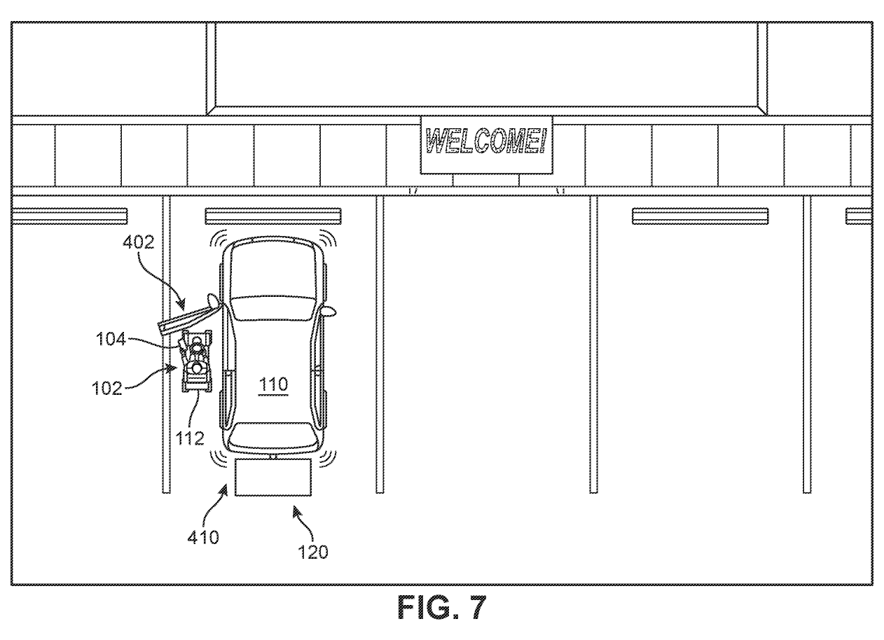

Upon reaching the target location, which is an area directly adjacent a driver-side door 402 of motor vehicle 110, as in FIG. 6, user 102 may easily transition from motor vehicle 110 to mobility device 112, as in FIG. 7. At this time, user 102 may disengage the autonomous driving system using either an associated UI on a user device 104, or through one or more controls of mobility device 112. In some cases, the autonomous driving system is automatically disengaged as the location of user 102 and the location of mobility device 112 are determined to be substantially similar. For example, the UWB anchors of motor vehicle 110 may receive signals from user device 104, which may be used to determine a location of user device 104 (and, by proxy, the location of user 102).

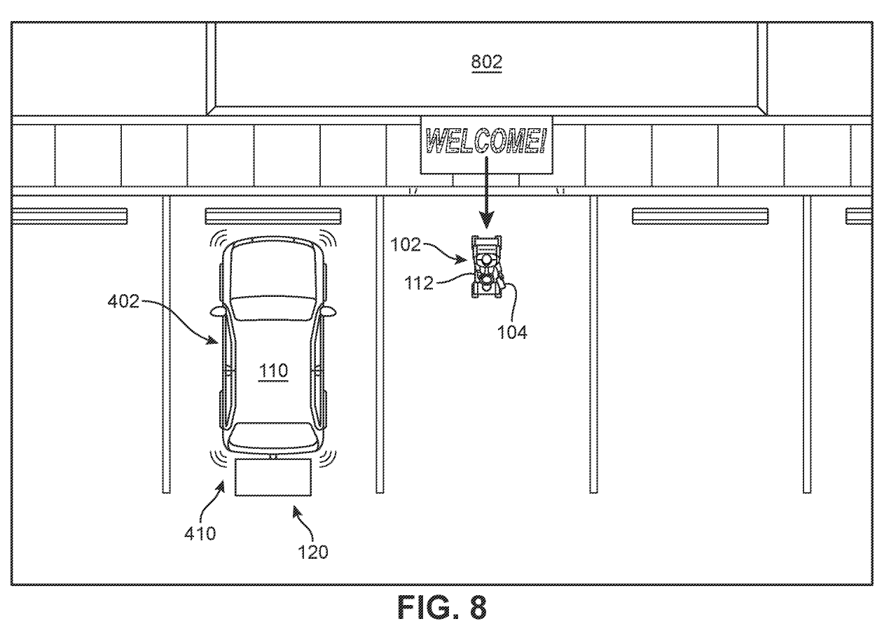

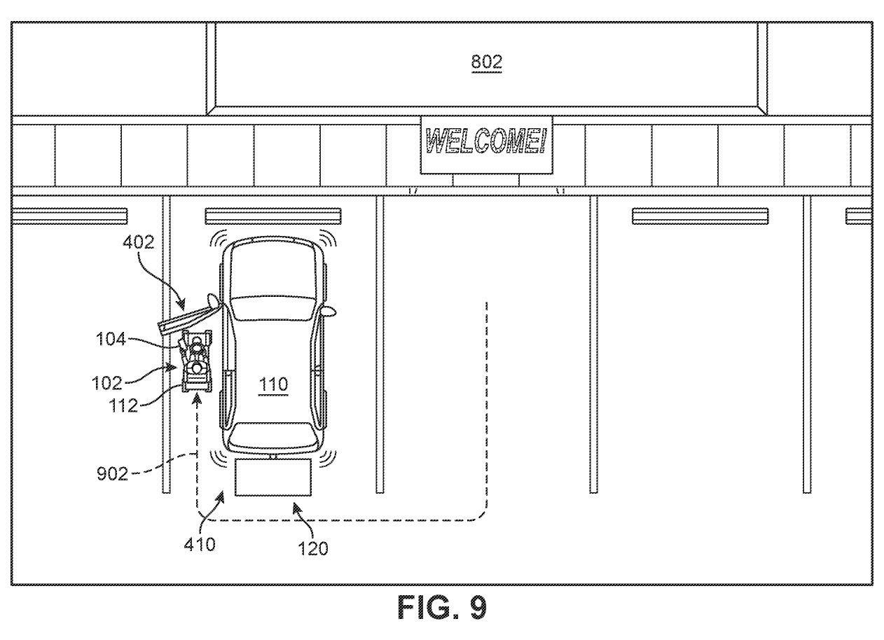

Referring next to FIGS. 8-11, mobility device 112 may autonomously stow itself at a rear of a vehicle once user 102 is ready to transition back to motor vehicle 110. In FIGS. 8-9, user 102 may manually drive mobility device 112 from a store 802 to driver-side door 402 of motor vehicle 110 along a path 902.

In some embodiments, a mobility system detects when a user has transitioned from mobility device 112 into a cabin of motor vehicle 110 and may automatically begin the process of stowing itself. In other embodiments, a user may initiate the stowing process after transitioning to motor vehicle 110 using a UI of user device 110 and/or a UI displayed within motor vehicle 110.

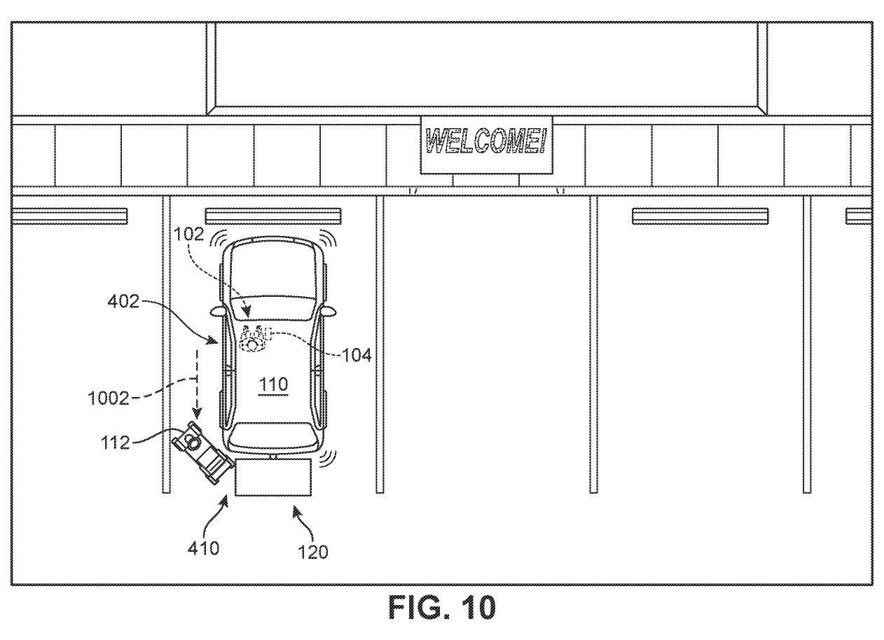

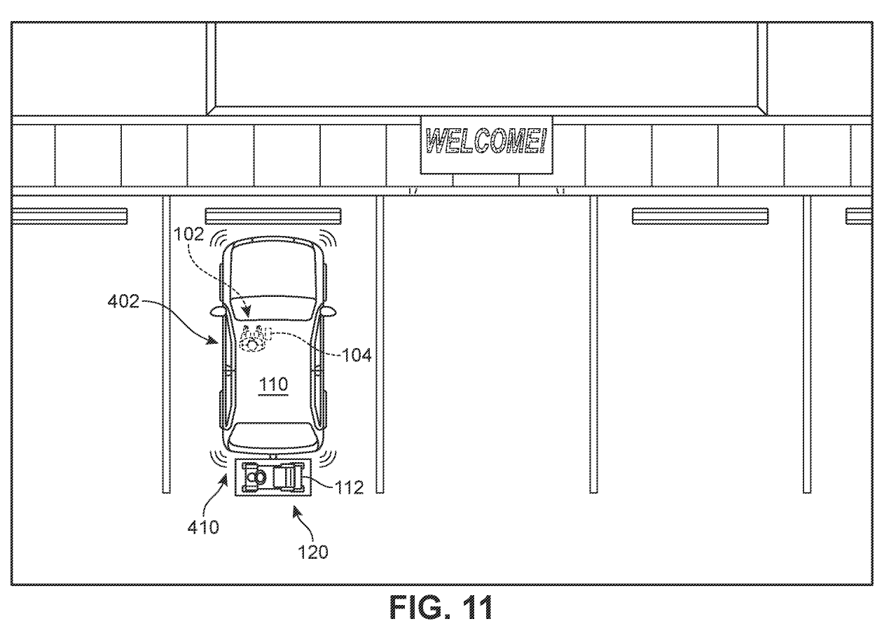

Once user 102 is back inside motor vehicle 110, mobility device 112 autonomously drives itself to a rear of motor vehicle 110 and loads itself onto a platform of lift system 120 for stowing, as in FIGS. 10-11. A path 1002 (see FIG. 10) taken by mobility device 112 from driver-side door 402 to rear side 410, may be determined according to the relative location of mobility device 112, which is determined in real time by the relevant UWB components of the system. Once mobility device 112 is disposed on a platform of lift system 120, lift system 120 may automatically raise and secure the mobility device at rear side 410 of motor vehicle 110.

Although not shown in FIGS. 4-11, the embodiments may also include provisions allowing mobility device 112 to autonomously travel to a docking station (such as home docking station 150 of FIG. 3) at a user’s home or other suitable location. where mobility device 112 may be charged while not in use.

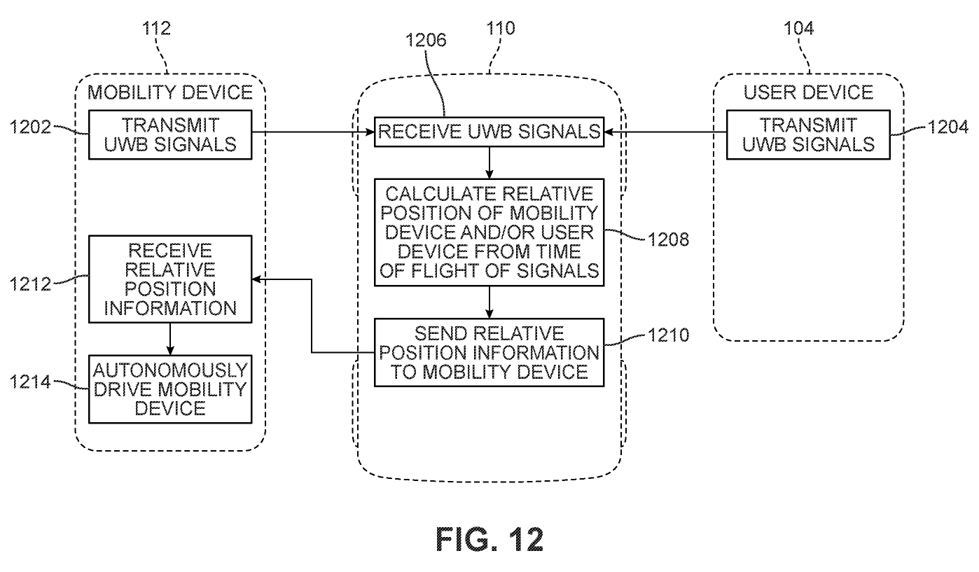

FIG. 12 is a schematic view of a process for a mobility system, according to an embodiment. The exemplary process depicts operations that may be performed by two or more entities, including operations performed by a mobility device 112, a motor vehicle 110, and a user device 104 (such as a mobile phone or wearable device).

Beginning with operation 1202, mobility device 112 transmits UWB signals (for example, using a UWB tag). Optionally, in some embodiments, UWB signals may be simultaneously transmitted by user device 104 in operation 1204.

UWB signals from one or more devices are received in operation 1206 at motor vehicle 110. For example, UWB signals transmitted by UWB tags on mobility device 112 and user device 104 may be received using suitable UWB anchors onboard of motor vehicle 110.

In operation 1208, the UWB signals are processed and used to calculate relative position information for mobility device 112 and/or user device 104 using time of flight information from these signals and any suitable algorithms. This relative position information is then transmitted back to mobility device 112, in operation 1210, and received at mobility device 112 in operation 1212. In some cases, information may be transmitted and received using appropriate UWB components. In other cases, information may be transmitted and received using any other suitable communication components over any suitable networks.

In operation 1214, mobility device 112 may use the relative position information for mobility device 112 (and possibly for user device 104, which serves as a proxy for the user’s location) to autonomously drive mobility device 112 to an appropriate area around motor vehicle 110. The area may be selected according to other provided information including whether the mobility device is being summoned or stowed. In some cases, motor vehicle 110 provides the target location/area along with the relative location information sent in operation 1210.

It is contemplated that a mobility system 100 may use various information to perform automated decision processes. As one example, a mobility system 100 may utilize information about the state of a vehicle door, for example whether the door is open or closed, when determining an autonomous path between locations around a vehicle. Therefore, in some embodiments, when transmitted location information to a mobility device, a system onboard a motor vehicle may also send information about the open/closed states of one or more doors such that the autonomous driving system of the mobility device has sufficient information for avoiding these obstacles and/or for stopping at suitable locations that prevent the mobility device from being hit by a door when a user exits a vehicle.

As previously discussed, the exemplary system may determine a location for a user using a mobile phone or wearable device location as a proxy. This allows the system to ensure the mobility device does not, for example, begin to drive away for stowing before a user has transitioned from the mobility device to the motor vehicle. The high precision of UWB location methods allows the system to determine the relative distances between components to within tens of centimeters or less, which is significantly less than a distance between a mobility device and an interior of a motor vehicle when the mobility device is parked beside the motor vehicle.

Moreover, it may be appreciated that the exemplary system may be used to summon a mobility device to any location that is sufficiently close to the motor vehicle such that the location of the user and/or mobility device may be determined. For example, a user may summon a mobility device to a front door of a house using a mobile device, so long as the front door is sufficiently close to the motor vehicle that the mobile device location and mobility device location may be determined with sufficient accuracy using the UWB anchors onboard the motor vehicle. In some embodiments, the UWB systems works to accurately locate a mobility device when the mobility device is within a radius of approximately ten meters from the motor vehicle. In some embodiments, a combination of Bluetooth Low Energy (BLE) and UWB may be used to summon a vehicle from a distance beyond a radius where UWB alone is sufficiently accurate for locating a mobility device. As an example, BLE may be used to initiate communication between a motor vehicle and a mobility device at longer distances (for example, at one to two hundred meters). As the mobility device moves closer to the motor vehicle (for example, comes within approximately ten meters of the motor vehicle), the system may switch to using UWB for communication and location functionality to ensure precise guidance for the mobility device as it moves to locations around the motor vehicle.

The embodiments describe methods of using ultra-wideband for determining sufficiently precise locations for mobility devices (relative to the location of a motor vehicle). However, other embodiments may employ any other suitable wireless technology for enabling communication and location functionality. In another embodiment, for example, rather than using ultra-wideband technology, communication and location functionality may be performed using BLE, for example by using BLE channel sounding for precisely locating a mobility device relative to a motor vehicle.

The following includes definitions of selected terms employed herein. The definitions include various examples and/or forms of components that fall within the scope of a term and that may be used for implementation. The examples are not intended to be limiting. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system includes one or more processors. A “processor”, as used herein, generally processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

The apparatus and methods described herein and illustrated in the accompanying drawings by various blocks, modules, components, circuits, steps, processes, algorithms, etc. (collectively referred to as “elements”) may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

The processor may be connected to a communication infrastructure (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system may include a display interface that forwards graphics, text, and other data from the communication infrastructure (or from a frame buffer) for display on a display unit. Display unit may include display, in one example. Computer system also includes a main memory, e.g., random access memory (RAM), and may also include a secondary memory. The secondary memory may include, e.g., a hard disk drive and/or a removable storage drive, representing a floppy disk drive, a magnetic tape drive, an optical disk drive, etc. The removable storage drive reads from and/or writes to a removable storage unit in a well-known manner. Removable storage unit, represents a floppy disk, magnetic tape, optical disk, etc., which is read by and written to removable storage drive. As will be appreciated, the removable storage unit includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals, which may be electronic, electromagnetic, optical or other signals capable of being received by communications interface. These signals are provided to communications interface via a communications path (e.g., channel). This path carries signals and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals. These computer program products provide software to the computer system. Aspects described herein may be directed to such computer program products. Communications device may include communications interface.

Computer programs (also referred to as computer control logic) are stored in main memory and/or secondary memory. Computer programs may also be received via communications interface. Such computer programs, when executed, enable the computer system to perform various features in accordance with aspects described herein. In particular, the computer programs, when executed, enable the processor to perform such features. Accordingly, such computer programs represent controllers of the computer system.

In variations where aspects described herein are implemented using software, the software may be stored in a computer program product and loaded into computer system using removable storage drive, hard disk drive, or communications interface. The control logic (software), when executed by the processor, causes the processor to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The foregoing disclosure of the preferred embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art may readily appreciate that the sequences may be varied and still remain within the spirit and scope of the present embodiments.

1. A system, comprising:
a motor vehicle, including:
a plurality of ultra-wideband anchors;
a positioning system for determining location information from signals received at the plurality of ultra-wideband anchors; and
a mobility device, including:
an autonomous driving system;
an ultra-wideband tag;
wherein the motor vehicle is configured to:
receive signals from the ultra-wideband tag at the plurality of ultra-wideband anchors;
determine position information for the mobility device using the positioning system and the signals from the ultra-wideband tag; and
transmit the position information to the mobility device;
wherein the mobility device is configured to:
receive the position information; and
autonomously drive the mobility device using the autonomous driving system and the position information.

2. The system according to claim 1, wherein the position information is transmitted by one or more of the ultra-wideband anchors to the ultra-wideband tag.

3. The system according to claim 1, wherein the motor vehicle includes a first communication system that is separate from the plurality of ultra-wideband anchors, wherein the mobility device includes a second communication system that is separate from the ultra-wideband tag, and wherein the position information is transmitted from the first communication system and received by the second communication system.

4. The system according to claim 1, wherein the mobility device receives a current location and a destination from the motor vehicle as part of the position information, and wherein the autonomous driving system is configured to plan a path for the mobility device according to the current location and the destination.

5. The system according to claim 1, wherein the motor vehicle is configured to:
receives signals from an ultra-wideband tag associated with a user device;
determine a user location from the signals from the ultra-wideband tag associated with the user device; and
determine a destination for the mobility device using the information about the user location.

6. The system according to claim 1, wherein the mobility device is an electric wheelchair.

7. The system according to claim 1, wherein the plurality of ultra-wideband anchors includes four ultra-wideband anchors, and wherein each of the four ultra-wideband anchors are attached at one of four corners of the motor vehicle.

8. The system according to claim 1, wherein the plurality of ultra-wideband anchors includes at least one ultra-wideband anchor disposed inside a cabin of the motor vehicle.

9. A method of operating a motor vehicle, comprising:
receiving, at a plurality of ultra-wideband anchors attached to the motor vehicle, signals from an ultra-wideband tag attached to a mobility device;
calculating position information for the mobility device relative to the motor vehicle using the signals from the ultra-wideband tag; and
transmitting the position information to the mobility device.

10. The method according to claim 9, wherein calculating position information is performed by a computing device in communication with the plurality of ultra-wideband anchors.

11. The method according to claim 10, wherein the computing device is disposed onboard the motor vehicle.

12. The method according to claim 10, wherein the position information is transmitted by the computing device.

13. The method according to claim 9, wherein the position information is transmitted by one or more of the plurality of ultra-wideband anchors.

14. The method according to claim 9, wherein the plurality of ultra-wideband anchors includes four ultra-wideband anchors, and wherein each of the four ultra-wideband anchors are attached at one of four corners of the motor vehicle.

15. The method according to claim 9, wherein the method further includes:
receiving signals from a second ultra-wideband tag associated with a user device;
determining a user location from the signals from the second ultra-wideband tag associated with the user device; and
sending information about the user location to the mobility device.

16. A method of operating a mobility device, comprising:
emitting a signal using an ultra-wideband tag attached to the mobility device, wherein the signal is configured to be received and processed by a motor vehicle with a plurality of ultra-wideband anchors;
receiving location information for the mobility device from the motor vehicle with the plurality of ultra-wideband anchors; and
autonomously driving, using an autonomous driving system of the mobility device, the mobility device according to the location information.

17. The method according to claim 16, wherein the mobility device is an electric wheelchair.

18. The method according to claim 16, wherein autonomously driving the mobility device includes autonomously driving the mobility device between a first location adjacent a door of the motor vehicle and a second location adjacent a rearward end of the motor vehicle.

19. The method according to claim 16, wherein autonomously driving the mobility device includes autonomously driving the mobility device to a lift system attached to the motor vehicle.

20. The method according to claim 16, wherein the method further includes receiving an instruction to retrieve a passenger from the motor vehicle prior to autonomously driving the mobility device.
